(19) United States
(12) Patent Application Publication
(10) Pub. No.: US 2011/0286215 A1
(43) Pub. Date: Nov. 24, 2011

(54) LIGHT STEEL FRAME LIGHTING STRUCTURE

(76) Inventor: YU-LIN PENG, TAIPEI CITY (TW)

(21) Appl. No.: 13/018,657

(22) Filed: Feb. 1, 2011

(30) Foreign Application Priority Data
May 20, 2010 (TW) 099209443

(51) Int. Cl. F21S 4/00

(52) U.S. Cl. 362/249.02; 362/249.01

(57) ABSTRACT

A light steel frame lighting structure includes a main body on which at least one bulb socket is disposed. At least one light bulb inbuilt with a stabilizer is installed in the bulb socket. At least one light-focusing board is disposed on the main body for enhancing illumination of the light steel frame (or T-bar made of other materials) lighting structure. The light bulbs are all inbuilt with stabilizers and directly electrically connected to the bulb sockets of the main body for use. In case of failure of any light bulb, it is only necessary to replace the failing light bulb with a new one inbuilt with a stabilizer to restore the light steel frame lighting structure to its original state. Accordingly, the repair and maintenance of the light steel frame lighting structure can be more conveniently performed.

### BACKGROUND OF THE INVENTION

1. Field of the Invention

The present invention relates generally to an improved light steel frame (or T-bar made of other materials) lighting structure, and more particularly to a lighting structure employing light bulbs inbuilt with stabilizers. The lighting structure can be conveniently repaired and maintained.

2. Description of the Related Art

A conventional light steel frame light includes a main body fixed on a ceiling. A grid and multiple lamp tubes are installed on the main body at intervals. The grid serves to avoid drop of the lamp tubes. In addition, each lamp tube is provided with a corresponding stabilizer disposed on the main body and connected with the lamp tube. The stabilizer serves to control current that passes through the lamp tube so as to avoid damage of the lamp tube due to over current.

However, in case the lamp tube fails to emit light due to unknown reason, a user is often hard to know whether the lamp tube or the stabilizer fails. Therefore, in general, the user needs to prepare both a new lamp tube and a new stabilizer to solve the problem. This is quite inconvenient.

### SUMMARY OF THE INVENTION

It is therefore a primary object of the present invention to provide an improved light steel frame (or T-bar made of other materials) lighting structure for overcoming the problem of inconvenience in repair that exists in the conventional lighting structure due to separation between light bulb and stabilizer.

To achieve the above and other objects, the light steel frame lighting structure of the present invention includes:

a main body having a seat body and multiple bulb sockets arranged on the seat body at intervals; and
multiple light bulbs, each light bulb being inbuilt with a stabilizer and having a connector, the connector being installed in and electrically connectable to the bulb socket of the main body.

The seat body is formed with a receiving space. The receiving space has an inner top section. The bulb sockets are disposed on the inner top section, whereby the light bulbs emit light downward.

The receiving space further has inner sidewalls. The bulb sockets are disposed on the inner sidewalls, whereby the light bulbs emit light laterally to provide indirect illumination.

The main body further includes at least one light-focusing board. The light-focusing board has a bent or arcuate form and is disposed on the seat body. The bulb sockets are fixedly arranged on the seat body through the light-focusing board.

The light steel frame lighting structure further includes a grid detachably mounted on the seat body of the main body.

The present invention is advantageous over the conventional lighting structure in that the stabilizers are inbuilt in the light bulbs in substitution for the stabilizers disposed on the main body. Therefore, no matter which type of light bulbs are used and no matter which type of connectors the light bulbs have, the light bulbs can be directly electrically connected to the bulb sockets and used. In case of failure of any light bulb, it is only necessary to replace the failing light bulb with a new one inbuilt with a stabilizer. Accordingly, it is unnecessary to repeatedly test and judge whether the light bulb or the stabilizer fails. Therefore, the repair and maintenance of the light steel frame lighting structure can be more conveniently performed.

The present invention can be best understood through the following description and accompanying drawings, wherein:

### BRIEF DESCRIPTION OF THE DRAWINGS

FIG. 1 is a perspective exploded view of a preferred embodiment of the light steel frame lighting structure of the present invention;

FIG. 2 is a perspective assembled view of the preferred embodiment of the light steel frame lighting structure of the present invention;

FIG. 3 is a side sectional view of the preferred embodiment of the light steel frame lighting structure of the present invention; and

FIG. 4 is a side sectional view of another embodiment of the light steel frame lighting structure of the present invention.

### DETAILED DESCRIPTION OF THE PREFERRED EMBODIMENTS

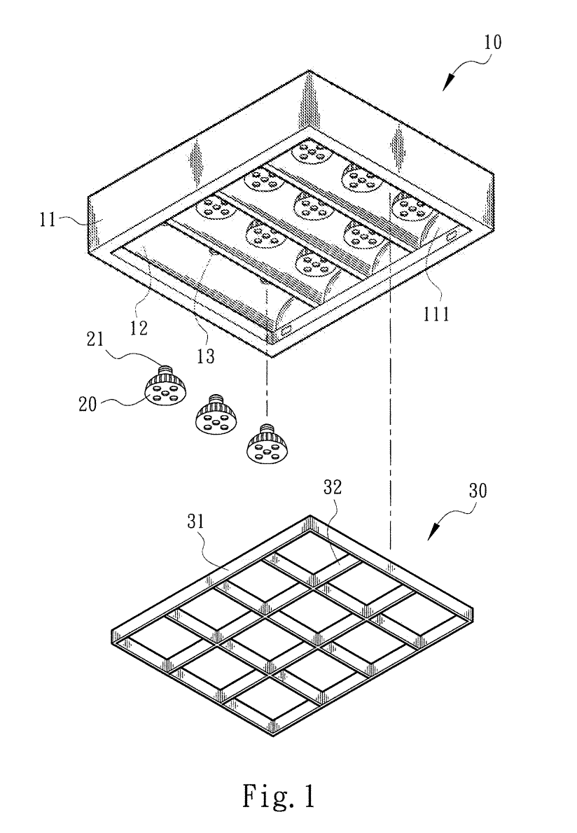

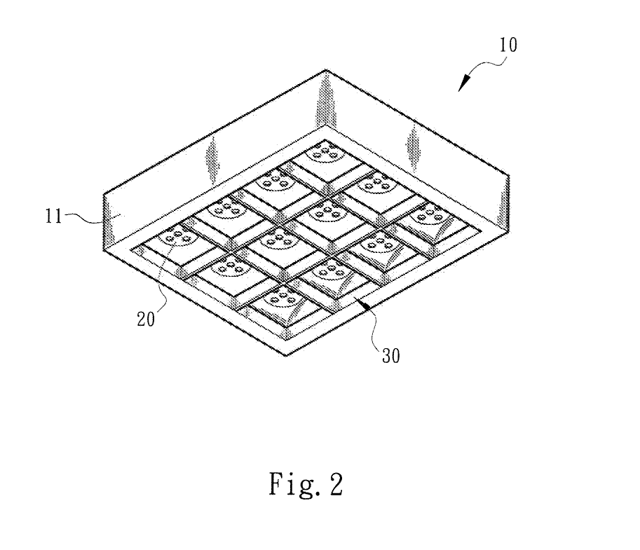

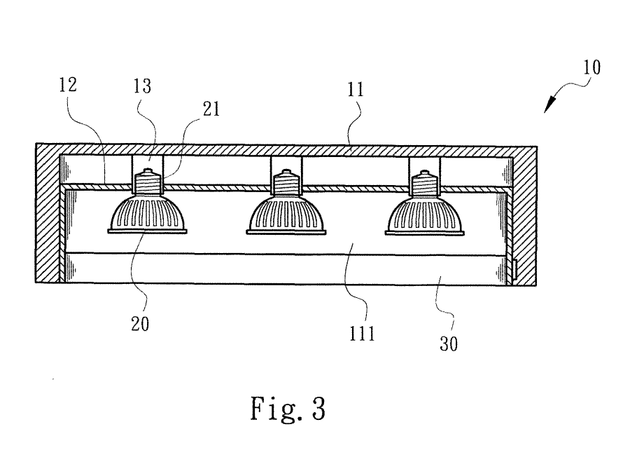

Please refer to FIGS. 1, 2 and 3. The light steel frame lighting structure of the present invention includes a main body 10 having a seat body 11 and at least one bulb socket 13. The light steel frame lighting structure further includes light bulbs 20 installed in the bulb sockets 13. The number of the light bulbs 20 is equal to the number of the bulb sockets 13. The bulb sockets 13 are electrically connected with each other.

The seat body 11 is mountable on a light steel frame or a ceiling. The seat body 11 has a panel directed in the projection direction. Alternatively, the seat body 11 can be recessed to form a receiving space 111 in adaptation to the panel. An inner top section and inner sidewalls are formed in the receiving space 111. The main body 10 further includes at least one light-focusing board 12 disposed on the panel of the seat body 11 or in the receiving space 111. The bulb sockets 13 are arranged at intervals and disposed on the seat body 11 through the light-focusing board 12. The light-focusing board 12 has a bent or arcuate form and is disposed on the panel or in the receiving space 111.

The light bulbs 20 can be gas discharge bulbs such as fluorescent light bulbs, metal halogen light bulbs and sodium light bulbs. Alternatively, the light bulbs can be light-emitting diode (LED) bulbs. Each light bulb 20 is inbuilt with a stabilizer (not shown). In addition, the light bulb 20 has a connector 21 installed in and electrically connectable to the bulb socket 13 of the main body 10. The light-focusing boards 12 disposed on the main body 10 serve to focus the light emitted from the light bulbs 20 to enhance illumination per unit area.

A grid 30 is disposed on the panel of the seat body 11 or in the receiving space 111. The grid 30 includes a frame 31 and multiple partitioning bars 32. The frame 31 has a configuration in adaptation to that of the inner sidewalls of the seat body 11 and is detachably installed on the seat body 11. The partitioning bars 32 are longitudinally and transversely interlacedly arranged within the frame 31 at intervals.

In this embodiment, the bulb sockets 13 of the main body 10 are disposed under the inner top section of the seat body 11. Accordingly, the light bulbs 20 installed in the bulb sockets 13 emit light downward to provide direct illumination with high brightness.

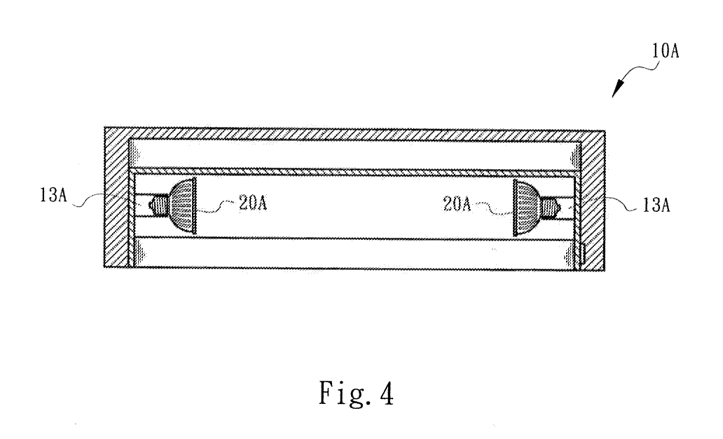

Please refer to FIG. 4, which shows the installation of another embodiment of the present invention. In this embodiment, the bulb sockets 13A of the main body 10A are disposed on the inner sidewalls of the seat body 11A and the light bulbs 20A emit light laterally to provide indirect soft illumination.

According to the above arrangement, the stabilizers are inbuilt in the light bulbs 20, 20A in substitution for the stabilizers disposed on the main body 10 or 10A. No matter which type of light bulbs 20, 20A are used and no matter which type of connectors (such as insertion type or screw type) the light bulbs 20, 20A have, the light bulbs 20, 20A can be directly electrically connected to the bulb sockets 13, 13A and used. In comparison with the conventional lighting structure, in case of failure of any light bulb, it is unnecessary to repeatedly install/uninstall the light bulb and stabilizer to judge whether the light bulb or the stabilizer fails. Instead, the light bulb can be directly replaced with a new one inbuilt with a stabilizer. On the other hand, it is unnecessary to prepare both the light bulb and the stabilizer for replacement. Accordingly, the repair and maintenance can be conveniently performed to reduce spare and consumptive materials.

The above embodiments are only used to illustrate the present invention, not intended to limit the scope thereof. Many modifications of the above embodiments can be made without departing from the spirit of the present invention.

What is claimed is:

1. A light steel frame lighting structure comprising:
a main body having a seat body and at least one bulb socket, the bulb sockets being disposed on the seat body; and
at least one light bulb, the light bulb being inbuilt with a stabilizer and having a connector, the connector being installed in and electrically connectable to the bulb socket.

2. The light steel frame lighting structure as claimed in claim 1, wherein a panel is disposed on the seat body and the bulb sockets are arranged on the panel.

3. The light steel frame lighting structure as claimed in claim 1, wherein the light steel frame lighting structure is characterized in that the seat body is formed with a receiving space, the receiving space having an inner top section, the bulb sockets being disposed on the inner top section.

4. The light steel frame lighting structure as claimed in claim 3, wherein the light steel frame lighting structure is characterized in that the receiving space has inner sidewalls, the bulb sockets being disposed on the inner sidewalls.

5. The light steel frame lighting structure as claimed in claim 1, wherein the light steel frame lighting structure is characterized in that the main body further includes at least one light-focusing board, the light-focusing boards being disposed on one side of the seat body, on which side the light sockets are disposed.

6. The light steel frame lighting structure as claimed in claim 2, wherein the light steel frame lighting structure is characterized in that the main body further includes at least one light-focusing board, the light-focusing boards being disposed on one side of the seat body, on which side the light sockets are disposed.

7. The light steel frame lighting structure as claimed in claim 3, wherein the light steel frame lighting structure is characterized in that the main body further includes at least one light-focusing board, the light-focusing boards being disposed on one side of the seat body, on which side the light sockets are disposed.

8. The light steel frame lighting structure as claimed in claim 5, wherein the light steel frame lighting structure is characterized in that the light-focusing board has a bent or arcuate form and is arranged on the main body.

9. The light steel frame lighting structure as claimed in claim 6, wherein the light steel frame lighting structure is characterized in that the light-focusing board has a bent or arcuate form and is arranged on the main body.

10. The light steel frame lighting structure as claimed in claim 7, wherein the light steel frame lighting structure is characterized in that the light-focusing board has a bent or arcuate form and is arranged on the main body.

11. The light steel frame lighting structure as claimed in claim 1, wherein the light steel frame lighting structure is characterized in that the lighting structure further comprises a grid detachably mounted on the seat body.

12. The light steel frame lighting structure as claimed in claim 2, wherein the light steel frame lighting structure is characterized in that the lighting structure further comprises a grid detachably mounted on the seat body.

13. The light steel frame lighting structure as claimed in claim 3, wherein the light steel frame lighting structure is characterized in that the lighting structure further comprises a grid detachably mounted on the seat body.

14. The light steel frame lighting structure as claimed in claim 11, wherein the light steel frame lighting structure is characterized in that the grid includes a frame and multiple partitioning bars, the frame having a configuration in adaptation to that of the seat body, the partitioning bars being longitudinally and transversely interlacedly arranged within the frame at intervals.

15. The light steel frame lighting structure as claimed in claim 12, wherein the light steel frame lighting structure is characterized in that the grid includes a frame and multiple partitioning bars, the frame having a configuration in adaptation to that of the seat body, the partitioning bars being longitudinally and transversely interlacedly arranged within the frame at intervals.

16. The light steel frame lighting structure as claimed in claim 13, wherein the light steel frame lighting structure is characterized in that the grid includes a frame and multiple partitioning bars, the frame having a configuration in adaptation to that of the seat body, the partitioning bars being longitudinally and transversely interlacedly arranged within the frame at intervals.

17. The light steel frame lighting structure as claimed in claim 1, wherein the light bulbs are LED bulbs.

18. The light steel frame lighting structure as claimed in claim 2, wherein the light bulbs are LED bulbs.

19. The light steel frame lighting structure as claimed in claim 3, wherein the light bulbs are LED bulbs.

20. The light steel frame lighting structure as claimed in claim 5, wherein the light bulbs are LED bulbs.
